(19) United States
(12) Patent Application Publication
(10) Pub. No.: US 2023/0386728 A1
(43) Pub. Date: Nov. 30, 2023

(54) Core for Stationary Electromagnetic Apparatus

(71) Applicant: Hitachi, Ltd., Tokyo (JP)

(72) Inventors: Chie KOBAYASHI, Tokyo (JP); Naoyuki KURITA, Tokyo (JP); Kohei YAMAGUCHI, Tokyo (JP); Mizuki OGI, Tokyo (JP)

(21) Appl. No.: 18/203,397

(22) Filed: May 30, 2023

(30) Foreign Application Priority Data
May 31, 2022 (JP) 2022-088176

(51) Int. Cl. H01F 27/25; H01F 27/34; H01F 41/02

(52) U.S. Cl. CPC H01F 27/25; H01F 27/34; H01F 41/0226

(57) ABSTRACT

Provided is a core for a stationary electromagnetic apparatus, in which a compressive stress load in the laminating direction of amorphous thin strips that form an amorphous core is suppressed so that noise generated by magnetostrictive vibration is reduced while maintaining a space factor of the amorphous core. The core for a stationary electromagnetic apparatus 10 according to the present invention includes: a laminated body 1 formed of amorphous metal thin strips; and a holding member 2 that holds the laminated body 1, in which a width b of the holding member 2 is equal to or more than a width a of the laminated body 1 in a laminating direction.

### CLAIM OF PRIORITY

The present application claims priority from Japanese Patent application serial no. 2022-088176, filed on May 31, 2022, the content of which is hereby incorporated by reference into this application.

### BACKGROUND OF THE INVENTION

The present invention relates to a core for a stationary electromagnetic apparatus.

### BACKGROUND

A stationary electromagnetic apparatus such as a transformer that is used for the conversion of a voltage for power transmission and distribution in an electric power system and the electrical insulation between electric wires of two systems has the following configuration. The stationary electromagnetic apparatus is formed by winding the windings of two systems on a high voltage side and a low voltage side to magnetic leg portions of a core made of a directional silicon steel plate that contains iron as a main component, a conductive soft magnetic material such as an amorphous alloy or a nanocrystal alloy or a non-conductive soft magnetic material such as ferrite. Currently, in forming the magnetic leg portion of the core of a distribution transformer that has a power capacity (rated capacity) of more than approximately 2 MVA and is used in a distribution substation or the like, mainly a directional electromagnetic steel plate is adopted by taking into account a balance between a mechanical strength, a cost and power efficiency. On the other hand, an amorphous core formed by laminating amorphous alloys each containing iron as a main component and having a thin strip shape has a magnetic loss that is half of a magnetic loss of the directional electromagnetic steel plate. Accordingly, the amorphous core is extremely useful in realizing a high efficiency of the stationary electromagnetic apparatus. Currently, the amorphous core is mainly adopted by a stationary electromagnetic apparatus having a small capacity of 2 MVA or less.

Japanese Unexamined Patent Application Publication No. 2000-124035 (patent literature 1) discloses an example of a core for a stationary electromagnetic apparatus that uses an amorphous core. In the Japanese Unexamined Patent Application Publication No. 2000-124035, there is disclosed an amorphous winding core transformer that includes: an amorphous winding core that is formed by winding an amorphous material thin strip in multiple layers; and a plurality of coils into which the amorphous winding core is inserted, in which, in the amorphous winding core, a space factor of the core portion is higher than a space factor of a yoke portion. According to the Japanese Unexamined Patent Application Publication No. 2000-124035, in the winding core, the space factor of the core portion 1a is higher than the space factor of the yoke portion and hence, an iron loss of the core portion 1a can be reduced. Further, an increased amount of an iron loss caused by lowering of the space factor of the yoke portion 1b can be cancelled by a reduced amount of the iron loss.

### SUMMARY OF THE INVENTION

In recent years, from a viewpoint of the protection of an environment around an electrical power substation, the noise regulation applied to respective facilities is becoming stricter. As one of noises that a transformer generates, an excitation noise is named, and magnetostrictive vibration of a core is considered as a main cause of the excitation noise. A magnetic strain is a phenomenon where, when a magnetic flux in a steel plate that forms a core changes, a shape of the steel plate changes in accordance with the change of the magnetic flux. Due to this phenomenon, when the core is subjected to an alternating-current excitation, the core is excited so that the core vibrates and a noise is generated. A magnetic strain of an amorphous thin strip is approximately 27 ppm, and is approximately 10 times as large as a magnetic strain of a silicon steel plate of a general core material.

Further, the amorphous thin strip is sensitive to a stress and hence, with respect to an amorphous core formed by laminating several thousands of thin strips, when a compression is applied to the core in the laminating direction, magnetostrictive vibrations that are generated in the respective thin strips are synthesized thus generating a large noise. Accordingly, it is necessary to adopt the core structure where a compressive stress is not applied in the laminating direction of the thin strips of the amorphous core. However, in the manufacture of the core in the past, the higher a space factor (=(the number of the thin strips×the thickness of thin strip)/(the width of the core in the laminating direction), the smaller the manufactured transformer becomes. Accordingly, a method for manufacturing a core is adopted where a space factor is increased, that is, the compression is generated in the thin strip direction. For example, in the above-mentioned Japanese Unexamined Patent Application Publication No. 2000-124035, to set the space factor of the magnet leg of the amorphous core higher than the space factor of the yoke of the amorphous core, amorphous metal thin strips are fastened in the laminating direction using a forming mold 3 and a fastening jig 4. Further, even when a fastening jig or the like is not used, since it is necessary to fix the core after inserting the core in a transformer tank, in general, an insulating material or the like is inserted between the core wirings. Accordingly, in steps of manufacturing the transformer, there is no ways but to apply a compressive stress to the amorphous core in the laminating direction of the amorphous core. Further, the larger a capacity of the transformer, the larger the above-mentioned compressive stress becomes and hence, the increase of noise becomes conspicuous.

The present invention has been made in view of the above-mentioned circumstances, and it is an object of the present invention to provide a core for a stationary electromagnetic apparatus provided with an amorphous core, in which a compressive stress load applied in the laminating direction of amorphous thin strips that form the amorphous core is suppressed so that noise generated by magnetostrictive vibration is reduced while maintaining a space factor of the amorphous core.

To overcome the above-mentioned drawbacks, according to a first aspect of the present invention, there is provided a core for a stationary electromagnetic apparatus that includes a laminated body formed of amorphous metal strips and a holding member that holds the laminated body. In the core for a stationary electromagnetic apparatus, a width of the holding member is equal to or more than a width of the amorphous metal strips in a laminating direction.

The more specific configurations of the present invention are described in claims.

According to the configuration of the present invention, with respect to a core for an stationary electromagnetic apparatus that uses an amorphous core, it is possible to provide a core for a stationary electromagnetic apparatus that can suppress a compressive stress load applied to amorphous thin strips that form the amorphous core in a laminating direction thus reducing noise caused by magnetostrictive vibration while maintaining a space factor of the amorphous core.

Other objects, configurations and advantageous effects besides the above-mentioned objects, configurations and advantageous effects will become apparent by the description of the embodiments made hereinafter.

### BRIEF DESCRIPTION OF THE DRAWINGS

FIG. 1A is a schematic view of an amorphous core according to a first embodiment;

FIG. 1B is a schematic view of a holding member.

FIG. 2A is a plan view illustrating three-phase five-leg core that uses the amorphous core according to the embodiment 1;

FIG. 2B is a front view of the three-phase five-leg core that uses the amorphous core according to the embodiment 1;

FIG. 3A is a plan view illustrating an example of a three-phase five-leg core that uses a conventional amorphous core;

FIG. 3B is a front view illustrating the example of the three-phase five-leg core that uses the conventional amorphous core, that is, an explanatory view of the example of the conventional three-phase five-leg core in a case where the present invention is not carried out;

FIGS. 4A to 4C are views illustrating a manufacturing flow of the amorphous core according to the present invention;

FIG. 5 is a graph illustrating the relationship between a space factor, a noise and a size of the amorphous core;

FIG. 6 is a schematic view of an amorphous iron according to a second embodiment;

FIG. 7 is a front perspective view of a stationary electromagnetic apparatus according to a third embodiment;

FIG. 8 is a cross-sectional view taken along a line A-A′ in FIG. 7;

FIG. 9 is a schematic view of the holding member whose end surfaces are inserted and fixed between the laminated body 1 and the silicon steel plates 4; and

FIG. 10 is a schematic view of a soundproof material arranged between the laminated body and the holding member.

### DETAILED DESCRIPTION OF THE PREFERRED EMBODIMENTS

Hereinafter, embodiments of the present invention are described in detail with reference to drawings. It must be noted that the present invention is not limited by the following embodiments.

### First Embodiment

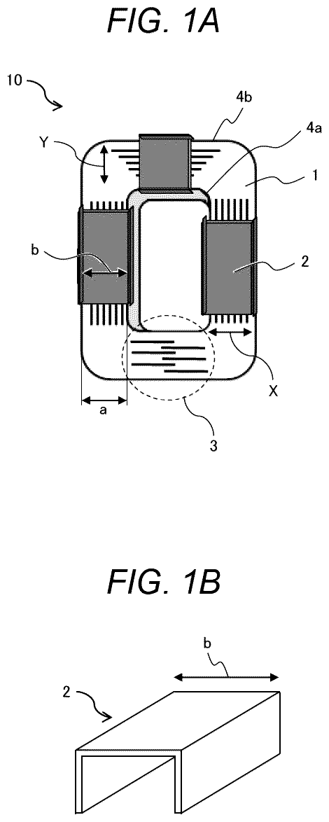

FIG. 1A is a schematic view of a core for a stationary electromagnetic apparatus (an amorphous core) according to a first embodiment. FIG. 1A is a view of the core by taking out only the core inserted into a transformer. As illustrated in FIG. 1A, the amorphous core 10 according to the present embodiment includes: a laminated body formed of amorphous metal thin strips (hereinafter also simply referred to as “laminated body”) 1; and holding members 2 that hold the laminated body 1 of the amorphous metal thin strips. The holding members 2 are formed so as to prevent a compressive stress from being applied in laminating directions (the direction indicated by an arrow X and the direction indicated by an arrow Y in FIG. 1A)) of the laminated body 1. A width b of the holding member 2 in the laminating direction is set equal to or more than a width a of the amorphous core 10. That is, the relationship of b≥a is established.

Silicon steel plates 4a, 4b are disposed on a surface on an innermost peripheral side and a surface on an outermost peripheral side of the amorphous core 10. The silicon steel plates 4a, 4b protect the amorphous metal thin strips that are likely to be easily chipped. The amorphous core 10 is formed into a substantially rectangular shape by laminating a plurality of amorphous metal thin strips that are magnetic materials having a thin plate shape. A closed magnetic circuit is formed by joining both ends of the amorphous metal thin strips in an overlapping manner at an overlapping portion 3.

FIG. 1B is a schematic view of the holding member 2. In the present embodiment, the holding member 2 is a member having a U-shaped cross-sectional shape. The holding member 2 covers a laminating surface (a surface formed by laminating a plurality of amorphous metal thin strips) of the laminated body 1, and is disposed so as to sandwich the innermost peripheral surface and the outermost peripheral surface of the laminated body 1. As described previously, by establishing the relationship of b≥a between the width b of the holding member 2 in the laminating direction and the width a of the amorphous core 10, it is possible to prevent a compressive stress from being applied to the laminated body 1 in the laminating direction of the laminated body 1. That is, portions of the laminated body 1 are covered by the holding member 2 having a size equal to or more than the width a so as to prevent the width a of the amorphous core 10 from becoming smaller due to an external force. A material of the holding member 2 may preferably be an insulating material or a non-magnetic material. This is because such a material can suppress a stray loss.

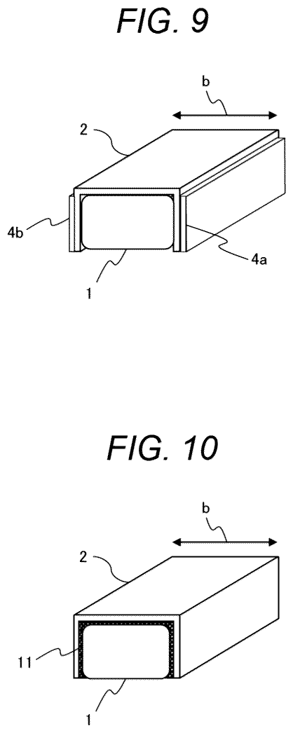

To fix the holding members 2 to the laminated body 1, it is preferable that the holding members 2 be made to adhere to a silicon steel plate 4a of the amorphous core 10 on an innermost peripheral side and to a silicon steel plate 4b of the amorphous core 10 on an outermost peripheral side by a resin. A contact surface between the holding member 2 and the silicon steel plate 4 may adopt a bellows structure so that the holding member 2 and the silicon steel plate 4 get caught with each other. Further, as illustrated in FIG. 9, both end surfaces of the holding member 2 may be inserted and fixed between the laminated body 1 and the silicon steel plates 4 (4a, 4b). Still further, as illustrated in FIG. 10, the core may adopt the configuration that can absorb vibration from the laminated body 1 by arranging a soundproof material 11 such as a sound absorbing material (rubber or the like) between portions of the laminated body 1 and portions of the holding member 2 that are brought into contact with each other.

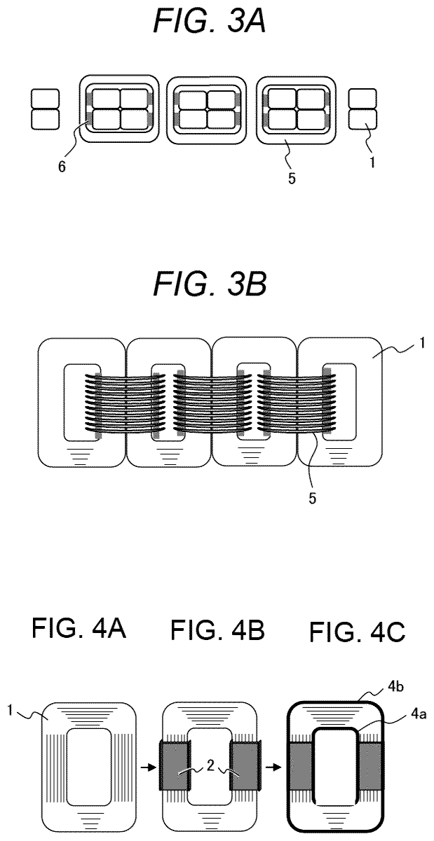

FIG. 3A and FIG. 3B are a plan view and a front view illustrating one example of a three-phase five-leg core used in a conventional amorphous core. As illustrated in FIG. 3A and FIG. 3B, the three-phase five-leg core that uses the conventional amorphous core is constituted of laminated bodies 1 and windings 5, and insulating members 6 are inserted between the laminated bodies 1 and the windings 5 so as to fix the core. However, the insulating member 6 is filled between the laminating body 1 and the winding 5 without forming any gap, a compressive stress is applied to the soft amorphous core and hence, noise is increased.

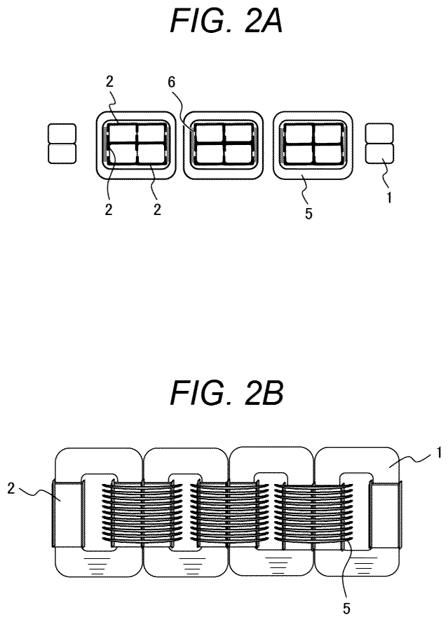

FIG. 2A and FIG. 2B are a plan view and a front view illustrating a three-phase five-leg core that uses the amorphous core described in the embodiment 1. In this embodiment, an insulating member 6 for fixing the laminated body 1 is disposed outside the holding member 2 and hence, the core has the structure where the insulating member 6 does not press the laminated body 1 but presses the holding member 2 disposed between the laminated body 1 and the winding 5. Accordingly, it is possible to fix the laminated body 1 without compressing the laminated body 1.

In this manner, in the present embodiment, the holding member 2 is provided for protecting the laminated body 1 from a compressive stress. Accordingly, the holding member 2 differs, in purpose and advantageous effects, from a member that is provided for fastening the laminated body 1 for increasing a space factor.

FIGS. 4A to 4C are views illustrating a manufacturing flow of the amorphous core according to the present invention. As steps of manufacturing the amorphous core, steps A to C are performed. Firstly, in the step A, the laminated body 1 formed of the amorphous metal thin strips that is obtained by laminating the amorphous metal thin strips and annealing the laminated amorphous metal thin strips is disposed. In the step B, the holding members 2 are mounted on the laminated body 1 formed of the amorphous metal thin strips. In the step C, the silicon steel plates 4A and 4B are mounted on a surface of an innermost periphery and a surface of an outermost periphery of the amorphous core thus forming the amorphous core in the shape where the holding member 2 is sandwiched by the silicon steel plates 4A and 4B.

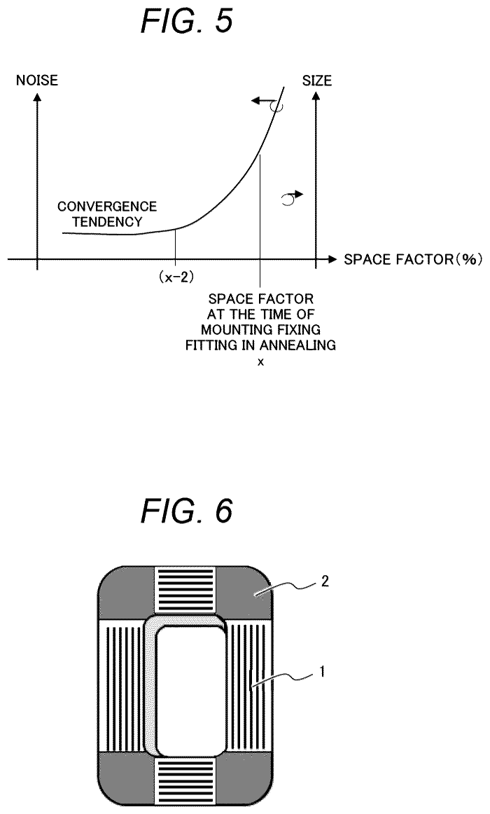

FIG. 5 is a graph illustrating the relationship between a space factor, noise and a size of the amorphous core. As illustrated in FIG. 5, the higher the space factor of the amorphous core, the smaller the size of the amorphous core becomes (a graph indicated by a dotted line in FIG. 5) and the larger the magnitude of the noise becomes (a graph indicated by a solid line in FIG. 5). That is, a trade-off is established between the space factor and the magnitude of noise.

The amorphous core is, after the amorphous metal thin strips are laminated to each other, annealed so as to eliminate a residual stress. At the time of annealing the amorphous core, it is necessary to support the amorphous core and hence, the core is fixed with a fitting. Assuming a case where the space factor of the core is x at this point of time, as illustrated in FIG. 5, it is desirable to set a width of the holding member such that the amorphous core has the space factor that is lowered by 2% or more with respect to x. That is, to express the width of the holding member using the space factor (x−2)% of the core, the following expression is obtained.

the width of the holding member=(the number of the thin strips×the thickness of one thin strip)/(the space factor of the core after annealing÷1.02)

The higher the space factor of the amorphous core, the smaller the size of the amorphous core becomes. Accordingly, by setting the width of the holding member to a value larger than the width of the core as described above, the noise can be reduced while maintaining the space factor.

### Embodiment 2

FIG. 6 is a schematic view of an amorphous core according to a second embodiment. As illustrated in FIG. 6, a holding member 2 may be disposed at four corners of a laminated body 1 formed of amorphous metal thin strips. The positions where the holding members 2 are disposed are not particularly limited. It is sufficient that the holding members 2 are disposed at positions where the holding members 2 can hold the laminated body 1 formed of the amorphous metal thin strips such that the position of the laminated body 1 is not displaced. However, it is preferable that the holding members 2 be formed in a shape that does not cover the entirety of the laminated surfaces of the amorphous core 10 for the purpose of cutting off a circulating current that flows through the amorphous core 10.

Also in the configuration of the embodiment 2, in the same manner as the configuration of the embodiment 1, it is possible to form the core without applying a compressive stress to the amorphous core in the laminating direction of the amorphous metal thin strips while maintaining a space factor of the amorphous core 10.

### Embodiment 3

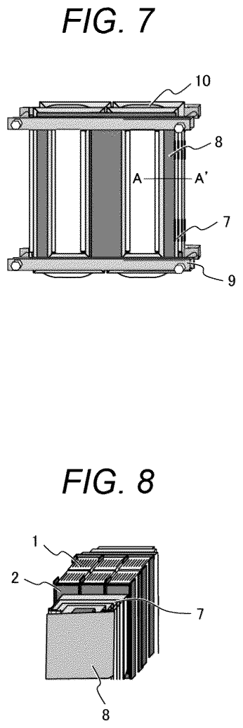

FIG. 7 is a front perspective view of a stationary electromagnetic apparatus according to an embodiment 3, and FIG. 8 is a cross-sectional view of the stationary electromagnetic apparatus taken along a line A-A′ in FIG. 7. FIG. 7 illustrates a hybrid core formed in a rectangular shape. The hybrid core is constituted of: the amorphous core 10 according to the embodiment 1 or 2; and laminated cores (silicon steel plate laminated cores) 7 that are each formed by laminating a plurality of magnetic material having a thin plate shape made of a directional electromagnetic steel plate and are disposed on both end sides of the amorphous core 10.

The stationary electromagnetic apparatus includes the structure where patch plates 8 are disposed on outer sides of the silicon steel plate laminated core 7, and the amorphous core 10 and the silicon steel plate laminated cores 7 are fastened to each other by a fastening jig 9 by way of the patch plates 8.

The holding members 2 are disposed in a U shape such that a beam is formed in a laminated layer end surface direction of the amorphous metal thin strip laminated body 1. With such a configuration, even when the entirety of the hybrid core is fastened, the holding members 2 directly receive a stress and hence, it is possible to avoid applying of a compressive stress to the amorphous metal thin strip laminated bodies 1 by fastening. Accordingly, with the provision of such a structure, while maintaining a space factor of the amorphous core 10, a compressive stress applied to the amorphous core 10 can be reduced and hence, it is possible to acquire an advantageous effect that noise generated in the amorphous core can be reduced. Further, with the provision of such a structure, a space factor of the amorphous core 10 can be maintained and hence, the structure contributes to the increase of power efficiency of the stationary electromagnetic apparatus.

As has been described above, it has been proven that, according to the present invention, it is possible to provide a stationary electromagnetic apparatus provided with an amorphous core, in which a compressive stress load in the laminating direction of amorphous thin strips that form the amorphous core is suppressed so that noise generated by magnetostrictive vibration is reduced while maintaining a space factor of the amorphous core.

According to the present invention, it is possible to provide a core for a stationary electromagnetic apparatus that can reduce noise while maintaining a space factor at a high value using an amorphous core having a low iron loss.

The present invention is not limited to the above-mentioned embodiments, and includes various modifications. For example, the above-mentioned embodiments have been described in detail for facilitating the understanding of the present invention, and the present invention is not always limited to the stationary electromagnetic apparatus provided with the entire configuration described above. Further, a part of the configuration of one embodiment can be replaced with the configuration of another embodiment. It is also possible to add the configuration of another embodiment to one embodiment. Further, with respect to a part of the configuration of each embodiment, the addition, the deletion and the replacement of other configurations may be allowed.

### REFERENCE SIGNS LIST

1: laminated body of amorphous metal thin strips
2: holding member
3: overlapping portion of amorphous core
4a: silicon steel plate disposed on side surface of amorphous core on innermost peripheral side
4b: silicon steel plate disposed on side surface of amorphous core on outermost peripheral side
5: winding
6: insulating material inserted for fixing core
7: silicon steel plate laminated core
8: patch plate
9: fastening jig for fixing core
10: core for stationary electromagnetic apparatus (amorphous core)

What is claimed is:

1. An core for a stationary electromagnetic apparatus comprising:
a laminated body formed of amorphous metal thin strips; and
a holding member that holds the laminated body, wherein
a width of the holding member is equal to or more than a width of the amorphous metal thin strips in a laminating direction.

2. The core for a stationary electromagnetic apparatus according to claim 1, wherein the holding member is formed into a shape and a size that prevent a compressive stress from being applied to the laminated body in a laminating direction of the laminated body.

3. The core for a stationary electromagnetic apparatus according to claim 1, wherein the holding member is a member having a U-shaped cross section, and is disposed so as to sandwich an innermost peripheral surface and an outermost peripheral surface of the laminated body.

4. The core for a stationary electromagnetic apparatus according to claim 1, wherein the laminated body is formed in a rectangular shape by laminating a plurality of the amorphous metal thin strips, and forms a closed magnetic circuit by joining both ends of the laminated body in an overlapping manner, and
the holding member is mounted on corner portions of the laminated body having a rectangular shape.

5. The core for a stationary electromagnetic apparatus according to claim 1, wherein a silicon steel plate is disposed on at least one of an innermost peripheral surface and an outermost peripheral surface of the laminated body, and
a part of the holding member is fixed to the silicon steel plate.

6. The core for a stationary electromagnetic apparatus according to claim 1, wherein the holding member is made of an insulating material or a non-magnetic material.

7. The core for a stationary electromagnetic apparatus according to claim 1, wherein a soundproof material is disposed between the laminated body and the holding member.

8. The core for a stationary electromagnetic apparatus according to claim 5, wherein both end surfaces of the holding member are inserted between the laminated body and the silicon steel plate.
